(19) United States
(12) Patent Application Publication
(10) Pub. No.: US 2022/0405759 A1
(43) Pub. Date: Dec. 22, 2022

(54) SALES MANAGEMENT SYSTEM

(71) Applicant: TOSHIBA TEC KABUSHIKI KAISHA, Tokyo (JP)

(72) Inventor: Kiyomitu YAMAGUCHI, Izunokuni Shizuoka (JP)

(73) Assignee: TOSHIBA TEC KABUSHIKI KAISHA, Tokyo (JP)

(21) Appl. No.: 17/588,891

(22) Filed: Jan. 31, 2022

(30) Foreign Application Priority Data
Jun. 21, 2021 (JP) 2021-102457

(51) Int. Cl. G06Q 20/40; G06Q 20/18; G06Q 20/32; G07C 9/10

(52) U.S. Cl. CPC G06Q 20/4016; G06Q 20/18; G06Q 20/322; G06Q 20/3276; G07C 9/10

(57) ABSTRACT

A sales management system includes a registration device having a processor configured to perform commodity registration based on operation of a customer who purchases a commodity. The sales management system also includes a gate device having a processor configured to execute error processing in response to receiving, as an input, information indicating that payment for the commodity registered by the registration device is completed is not input when the customer passes the gate device. The processor of the registration device is also configured to receive stop information indicating that the customer stops shopping without purchasing the commodity output information for passing the gate device. The processor of the gate device is also configured to receive, as the input, the information for passing the gate device, and allow passage of the customer without executing the error processing.

### CROSS-REFERENCE TO RELATED APPLICATION

This application is based upon and claims the benefit of priority from Japanese Patent Application No. 2021-102457, filed on Jun. 21, 2021, the entire contents of which are incorporated herein by reference.

### FIELD

Exemplary embodiments described herein relate to a sales management system.

### BACKGROUND

In a store such as a supermarket or a volume retail store, manpower saving has been advanced as a result of a labor shortage. For example, stores introducing a system in which customers purchasing a commodity and a service (hereinafter collectively referred to as “commodity”) register the commodity themselves and make payment in a checkout device have been increasing.

In order to suppress the customer from fraudulently exiting the store without making payment, such a store takes measures for, for example, providing a gate device in a checkout area where the checkout device is set or an exit of the store. As a gate device of this type, a gate device reads a code symbol printed on a receipt dispensed by the checkout device to check that the customer completes payment and allows the customer to pass the gate device (for example, JP-A-2017-187911 (Patent Literature 1)). The customer correctly making payment can normally exit the checkout area or the store (hereinafter referred to as “normal store exit” as well) without the gate device performing any abnormal processing.

In order to effectively suppress a fraudulent store exit of a customer, some stores adopt an operation for causing all customers entering a selling floor to exit the store after passing a gate device. However, if this operation is adopted, a customer entering the selling floor but not purchasing any commodity as a result cannot pass the gate device and normally exit the store because the customer does not have a receipt.

### DESCRIPTION OF THE DRAWINGS

FIG. 1 is a diagram illustrating an overview of a sales management system in accordance with an exemplary embodiment;

FIG. 2 is a diagram illustrating a selling floor of a store that adopts the sales management system in accordance with the exemplary embodiment;

FIG. 3 is a diagram illustrating an operation overview from an entry into the selling floor until an exit from the selling floor of a customer in accordance with the exemplary embodiment of FIG. 1;

FIG. 4 is a block diagram illustrating a hardware configuration of a portable terminal in accordance with the exemplary embodiment of FIG. 1;

FIG. 5 is a block diagram illustrating a functional configuration of the portable terminal in accordance with the exemplary embodiment;

FIG. 6 is a block diagram illustrating a hardware configuration of a gate device in accordance with the exemplary embodiment of FIG. 1;

FIG. 7 is a block diagram illustrating a functional configuration of the gate device in accordance with the exemplary embodiment;

FIG. 8 is a diagram illustrating a receipt in accordance with the exemplary embodiment of FIG. 1;

FIG. 9 is a block diagram illustrating a hardware configuration of a store server in accordance with the exemplary embodiment of FIG. 1;

FIG. 10 is a diagram for explaining a data configuration of a status management file stored in a memory unit of the store server in accordance with the exemplary embodiment;

FIG. 11 is a diagram illustrating a data configuration of a processing master stored in the memory unit of the store server in accordance with the exemplary embodiment;

FIG. 12 is a diagram illustrating a data configuration of a customer fraudulence degree management file stored in the memory unit of the store server in accordance with the exemplary embodiment;

FIG. 13 is a block diagram illustrating a functional configuration of the store server in accordance with the exemplary embodiment;

FIG. 14 is a flowchart illustrating a flow of processing by a control unit of the portable terminal in accordance with the exemplary embodiment;

FIG. 15 is a flowchart illustrating a flow of processing by a control unit of the gate device in accordance with the exemplary embodiment;

FIG. 16 is a sequence chart illustrating a flow of the operation of a sales management system in an exemplary embodiment;

FIG. 17 is a flowchart illustrating a flow of processing by a control unit of a portable terminal in accordance with the exemplary embodiment of FIG. 16;

FIG. 18 is a sequence chart illustrating a flow of the operation of a sales management system in accordance with an exemplary embodiment; and

FIG. 19 is a flowchart illustrating a flow of processing by a control unit of a gate device in accordance with the exemplary embodiment of FIG. 19.

### DETAILED DESCRIPTION

An object of embodiments is to provide, in order to solve the problems described above, a sales management system that is capable of effectively suppressing a fraudulent store exit and enables a customer not purchasing any commodity to normally exit a store.

A sales management system according to an exemplary embodiment is a sales management system including: a registration device including a processor configured to perform commodity registration based on operation of a customer who purchases a commodity; and a gate device including a processor configured to execute error processing in response to receiving, as an input, information indicating that payment for the commodity registered by the registration device is completed is not input when the customer passes the gate device, wherein the processor of the registration device is further configured to: receive stop information indicating that the customer stops shopping without purchasing the commodity; and in response to receiving the stop information, output information for passing the gate device, and wherein the processor of the gate device is further configured to: receive, as the input, the information for passing the gate device; and in response to receiving, as the input, the information for passing the gate device, allow passage of the customer without executing the error processing.

A sales management system according to exemplary embodiments are explained below. These exemplary embodiments are not limited by the embodiments explained below. For example, in this embodiment, a portable terminal carried by a customer such as a smartphone installed with an application program for shopping is explained as an example of a registration device. However, not only this, but the registration device may include other devices in which commodity registration is executed by operation of a customer such as through a tablet terminal or a self-service POS (Point of Sales) terminal prepared by a store. If a customer passing a gate device in this exemplary embodiment is recognized as not normally exiting the store, as error processing, the gate device outputs an error message with sound or display. However, an opening and closing door of a gate device with the opening and closing door may be closed.

### First Embodiment

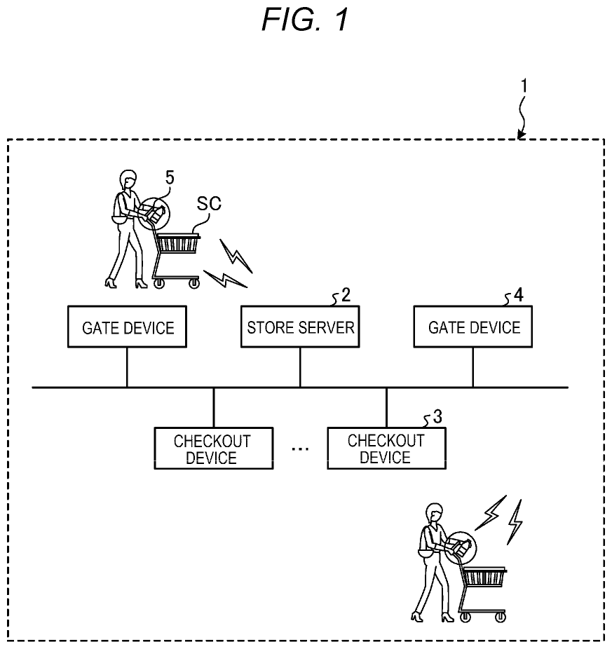

A sales management device in a first exemplary embodiment is explained below with reference to the drawings. FIG. 1 is a diagram illustrating an overview of a sales management system 1. In some embodiments, the sales management system 1 is applied to a store that sells commodities, for example, a supermarket. The sales management system 1 includes a store server 2, a plurality of checkout devices 3, a plurality of gate devices 4, and a portable terminal 5 carried by a customer. The store server 2, the checkout devices 3, and the gate devices 4 are communicably connected to one another via a network such as a LAN (Local Area Network). The portable terminal 5 is communicably connected to the store server 2 and the checkout devices 3 via a wireless LAN or the like. The sales management system 1 may separately include a POS terminal with which a store clerk performs operation concerning commodity registration and payment, a self-service POS terminal with which the customer performs operation concerning commodity registration and payment, and a semi-self-service POS system with which the store clerk performs operation concerning commodity registration and the customer performs operation concerning payment.

The store server 2 receives commodity information of a commodity for which checkout processing is executed and settlement information concerning a settlement method and the like from the checkout device 3. Further, the store server 2 receives sales information indicating a sales amount from the checkout device 3. The store server 2 centrally manages the received commodity information, settlement information, sales information, and the like and performs sales management and the like in one store.

The store server 2 acquires operation information of the customer from the portable terminal 5 and manages statuses from a store entry to a store exit for each customer. The statuses of the customer managed by the store server 2 are, for example, a store entry, execution and cancellation of commodity registration, settlement, and reading of information in the gate device 4. By managing such statuses of the customer, it is possible to estimate a fraudulent store exit of the customer and manage a fraudulence degree (possibility of a fraud) for each customer. In a system that leaves operation for commodity registration and payment to the customer as in some exemplary, non-limiting embodiments, since a fraud is easily committed, it is useful for the store to manage the fraudulence degree and take measures for each customer.

In some embodiments, the checkout device 3 is a checkout device of a so-called self-service type with which the customer performs checkout operation by himself or herself. The checkout device 3 executes, based on transaction information received from the portable terminal 5, checkout processing relating to payment by cash settlement or cashless settlement such as credit settlement. The checkout processing is processing for performing payment of a price of a commodity purchased by the customer. In the cash settlement, the checkout processing is, for example, display of transaction information, calculation of a change amount, and dispensing of change. In the credit settlement, the checkout processing is, for example, transmission and reception of various kinds of information to and from a settlement server of a settlement agent. The transaction information is information necessary for the checkout device 3 to execute the checkout processing and is information including commodity information such as a commodity name and a price of a commodity.

In some embodiments, the gate device 4 is provided in an exit of a settling floor where the checkout device 3 is set or an exit of the store (hereinafter collectively referred to as “selling floor exit” as well). The customer entering the selling floor exits the store passing the gate device 4 provided in the selling floor exit. If reading information indicating that the customer completed payment (hereinafter referred to as “payment completion information” as well) or information indicating that the customer stops shopping and does not purchase any commodity (hereinafter referred to as “information for passage” as well), the gate device 4 allows the customer to normally exit the store. If a customer whose completion of payment or stop of shopping cannot be confirmed attempts to pass the gate device 4, the gate device 4 executes error processing. The error processing is, for example, informing by sound or notification to a store clerk stationed in a checkout area. If the gate device 4 includes an opening and closing door, the error processing may be closing of the opening and closing door. In some exemplary, non-limiting embodiments, the informing by sound is adopted as the error processing. This is because, if the opening and closing door is closed to forcibly prohibit passage of the customer, it is likely that discomfort of the customer is caused.

The portable terminal 5 is a portable terminal carried by the customer. In some exemplary, non-limiting embodiments, the portable terminal 5 is configured by a smartphone installed with an application program for shopping and carried by the customer. The portable terminal 5 can perform commodity registration by imaging (e.g., with a camera, etc.) a code symbol such as a barcode attached to a commodity. The portable terminal 5 is an example of a registration device. The portable terminal 5 is capable of transmitting transaction information including commodity information of a registered commodity to the checkout device 3. Consequently, the customer can make payment in the checkout device 3. The portable terminal 5 is capable of transmitting the transaction information and a terminal ID to the store server 2. In some embodiments, the terminal ID is information for specifying the portable terminal 5 carried by the customer. In some embodiments, the terminal ID is information that can indirectly specify the customer. Instead of the terminal ID, a customer ID registered by the store beforehand can also be used. The portable terminal 5 can be placed on a placing section provided in a shopping cart SC.

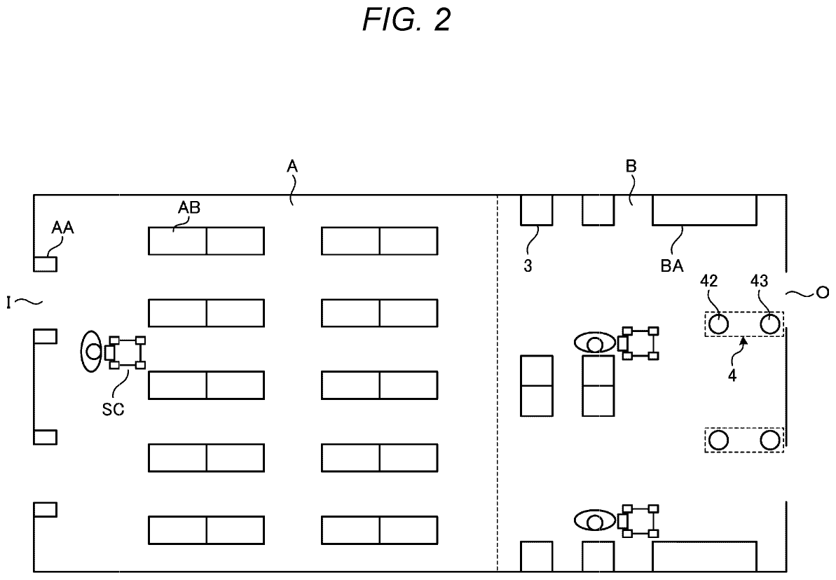

FIG. 2 is a diagram illustrating an exemplary embodiment of the selling floor provided in the store. The selling floor is configured from a commodity area A and a checkout area B.

In some embodiments, the commodity area A is an area where the customer moves while pushing the shopping cart SC and chooses a commodity to be purchased. In the commodity area A, selling floor entrances I for the customer to enter the selling floor are formed in two places. In the commodity area A, store-entry-code display units AA and display shelves AB are set.

The store-entry-code display units AA are respectively set on both sides of the selling floor entrances I. The store-entry-code display unit AA displays, for example, a two-dimensional code for store entry (hereinafter referred to as “store entry code” as well). The customer entering the selling floor reads the store entry code with the portable terminal 5, whereby the application program installed in the portable terminal 5 starts. Consequently, the portable terminal 5 becomes connectable to a network of the store and is capable of transmitting and receiving information (data) to and from the store server 2 and the checkout devices 3. A large number of display shelves AB are set in the commodity area A. Commodities sold by the store are displayed in the display shelves AB.

In some embodiments, the checkout area B is an area where the customer pays a price of a commodity to be purchased. The checkout area B is provided continuously to the commodity area A. The customer can freely come and go between the commodity area A and the checkout area B. In the checkout area B, selling floor exits O through which the customer completing the payment exits the selling floor are formed in two places. In the checkout area B, the checkout devices 3, the gate devices 4, and sacker tables BA are set.

As explained above, the checkout device 3 is a checkout device of a self-service type that the customer himself or herself operates to make payment. A plurality of checkout devices 3 are set to be located on both sides and in the center of the checkout area B. The sacker tables BA are set to be respectively located on both the side of the checkout area B. The sacker tables BA are work tables on which the customer performs bagging of purchased commodities. The gate devices 4 are set near the selling floor exits O. In some embodiments, the gate device 4 includes a reading gate 42 and a sensor gate 43.

In some embodiments, the reading gate 42 is disposed further on the commodity area A side than the sensor gate 43. The reading gate 42 includes a code reader 44 that reads information from a barcode printed on a receipt dispensed by the checkout device 3, a barcode included in an electronic receipt displayed on a display unit of the portable terminal in a store adopting the electronic receipt, or a two-dimensional code for exit (hereinafter referred to as “store exit code” as well) displayed on the display unit of the portable terminal 5 and a display unit 45 (see FIG. 6 for both of the code reader 44 and the display unit 45). In some embodiments, the information read by the code reader 44 is payment completion information indicated by the barcode of the receipt, information for passage indicated by the store exit code, and the like. The display unit 45 displays various kinds of information.

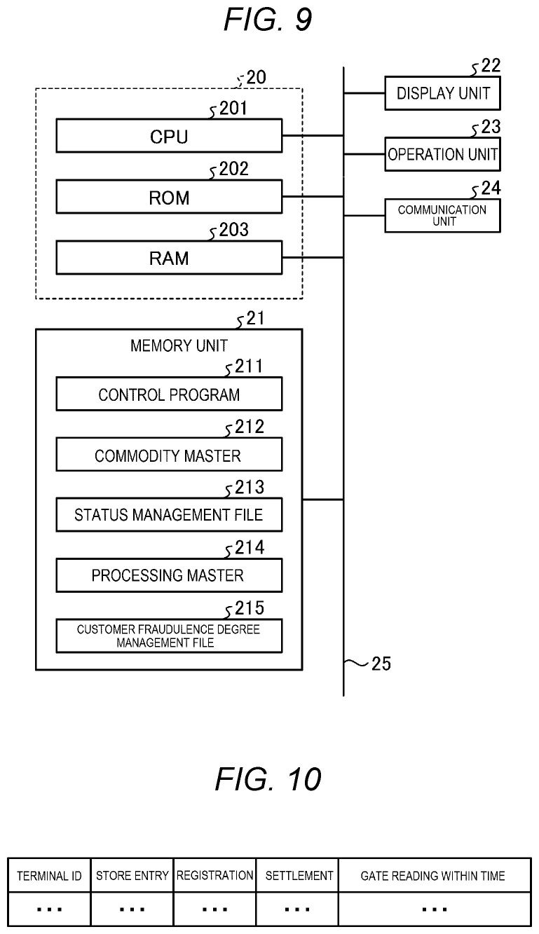

In some embodiments, the sensor gate 43 includes a passage sensor 46 that detects the passing customer and a sound output unit 47 such as a speaker (see FIG. 9 for both of the passage sensor 46 and the sound output unit 47). The passage sensor 46 is a sensor that detects the customer moving from the reading gate 42 side to the selling floor exit O side. Publicly-known various sensors can be used as the passage sensor 46. The sound output unit 47 informs information to the customer passing the gate device 4 and customers, store clerks, and the like present in the checkout area. The passage sensor 46 may be provided separately from the sensor gate 43. However, in this case as well, the gate device 4 including the passage sensor 46 is configured.

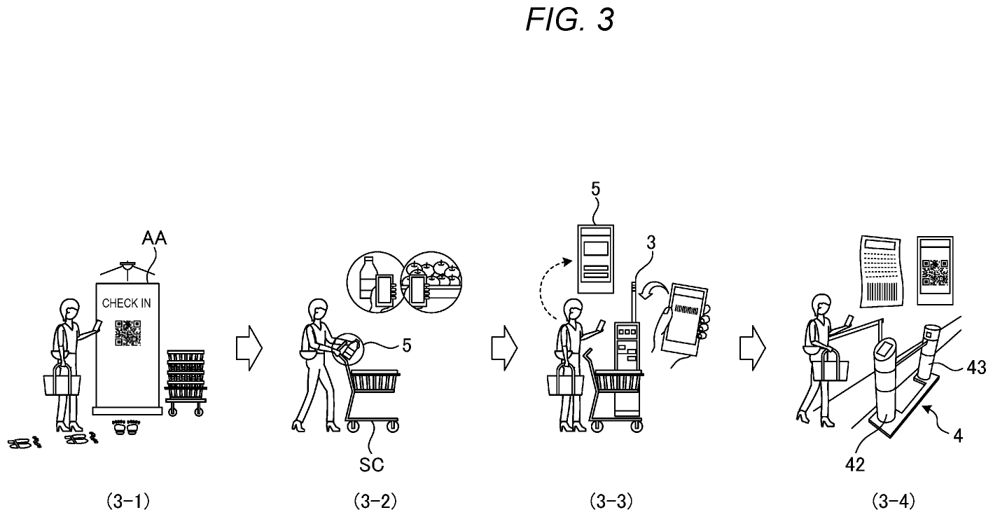

Exemplary, non-limiting embodiments of actions of the customer entering the selling floor, doing shopping, and exiting the selling floor are explained. FIG. 3 is a diagram illustrating an action overview from an entry into to an exit from the selling floor of the customer.

If entering the selling floor from the selling floor entrance I, first, the customer reads a store entry code displayed on the display unit AA with the portable terminal 5 installed with the application program for shopping (3-1). The customer moves in the commodity area A, for example, while pushing the shopping cart SC, reads barcodes attached to commodities to be purchased with the portable terminal 5, and performs commodity registration (3-2).

If the commodity registration of all the commodities to be purchased is completed, the customer moves to the checkout area B and transfers transaction information including commodity information registered by the commodity registration from the portable terminal 5 to the checkout device 3 (3-3). The customer can transfer the transaction information from the portable terminal 5 to the checkout device 3 by, for example, reading, from images of the barcodes displayed on the checkout device 3, payment codes for transferring transaction data. Subsequently, the customer performs payment in the checkout device 3 based on the transaction information. The payment is performed by cash settlement, credit settlement, electronic money settlement, or the like.

The customer finishing the payment takes a receipt dispensed by the checkout device 3 and moves to the selling floor exit O. A barcode indicating that the payment is completed is printed on the receipt in addition to commodity names, amounts, and the like of the commodities purchased by the customer. That is, information indicated by the barcode is an example of information indicating that the payment is completed. The receipt may be an electronic receipt viewable by the portable terminal 5. The customer causes the reading gate 42 provided in the selling floor exit O to read the barcode printed on the receipt, passes the gate device 4, and exits the selling floor (3-4). Consequently, the customer can normally exit the selling floor. For example, if the customer does not cause the reading gate 42 to read the barcode or causes the reading gate 42 to read a barcode of a receipt relating to a transaction in the past and attempts to pass the gate 4, the gate device 4 executes error processing. The error processing is processing for urging the reading gate 42 to read information for normal exit and is processing for performing a sound output such as “please hold the barcode of the receipt over the reading gate”.

Exemplary, non-limiting embodiments of the store server 2, the gate device 4, and the portable terminal 5 configuring the sales management system 1 are explained in detail.

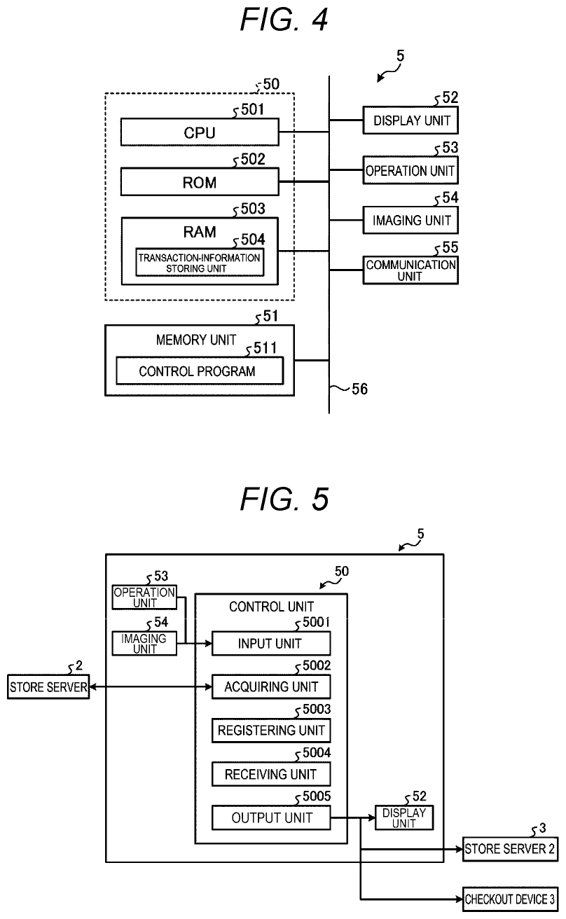

First, the portable terminal 5 is explained. FIG. 4 is a block diagram illustrating an exemplary hardware configuration of the portable terminal 5. The portable terminal 5 includes a control unit 50, a memory unit 51, a display unit 52, an operation unit 53, an imaging unit 54, and a communication unit 55. The control unit 50, the memory unit 51, the display unit 52, the operation unit 53, the imaging unit 54, and the communication unit 55 are connected to one another via a bus 56 or the like.

The control unit 50 is configured by a computer including a CPU (Central Processing Unit) 501, a ROM (Read Only Memory) 502, and a RAM (Random Access Memory) 503. The CPU 501, the ROM 502, and the RAM 503 are connected to one another via the bus 56.

The CPU 501 controls the operation of the entire portable terminal 5. The ROM 502 stores various programs such as a program used for driving of the CPU 501 and various data. The RAM 503 includes a transaction-information storing unit 504. The transaction-information storing unit 504 is an area where, in one transaction, transaction information including commodity information acquired from the store server 2 based on an input commodity code is stored. The RAM 503 is used as a work area of the CPU 501. The various programs and the various data stored in the ROM 502 and the memory unit 51 are loaded in the RAM 503. The CPU 501 operates according to a control program stored in the ROM 502 or the memory unit 51 and loaded in the RAM 503, whereby the control unit 50 executes various kinds of control processing for the portable terminal 5.

The memory unit 51 is configured by a storage medium such as a HDD (Hard Disk Drive) or a flash memory and maintains stored content even if the portable terminal 5 is turned off. The memory unit 51 stores a control program 511.

The control program 511 is an application program for shopping or the like. The application program for shopping causes the portable terminal 5 to function as a commodity registration device and causes the display unit 52 to display a store exit code indicating information for passage indicating that the customer stops shopping and does not purchase any commodity.

The display unit 52 is configured by, for example, a liquid crystal panel and displays various kinds of information. The display unit 52 displays, for example, commodity information of registered commodities and a total amount of the registered commodities. The display unit 52 displays various kinds of information such as a store exit code indicating information for passage and an operator for the customer, who is a user, to operate.

The operation unit 53 is configured by, for example, a touch panel provided on the surface of the display unit 52 and inputs information corresponding to a position touched by the user to the control unit 50. If the customer operates the operator displayed on the display unit 52, the operation unit 53 inputs information corresponding to the operator to the control unit 50.

The imaging unit 54 images a store entry code displayed on the store-entry-code display unit AA, a barcode attached to a commodity, a barcode displayed on the checkout device 3, and the like and inputs imaging data to the control unit 50. The control unit 50 reads store entry information from an image of the store entry code displayed on the store-entry-code display unit AA, reads a commodity code, which is commodity identification information for identifying the commodity from an image of the barcode attached to the commodity, and reads a payment code for transferring transaction data from an image of the barcode displayed on the checkout device 3. If the portable terminal 5 has a function of performing commodity registration using so-called object recognition, the imaging unit 54 images the exterior of a commodity and inputs an image to the control unit 50.

The communication unit 55 is an interface for communicating with external devices such as the store server 2, the checkout devices 3, and the gate devices 4. The control unit 50 is connected to the external devices via the communication unit 55 to be capable of transmitting and receiving information (data) to and from the external devices.

Subsequently, an exemplary functional configuration of the control unit 50 of the portable terminal 5 is explained. FIG. 5 is a block diagram illustrating main functional components of the control unit 50 of the portable terminal 5. The CPU 501 operates according to a control program stored in the ROM 502 or the memory unit 51, whereby the control unit 50 functions as an input unit 5001, an acquiring unit 5002, a registering unit 5003, a receiving unit 5004, and an output unit 5005. These functions maybe configured by hardware such as dedicated circuits.

Various kinds of information are input to the input unit 5001 from the operation unit 53 and the imaging unit 54. For example, number of people information indicating the number of people of a group of customers carrying portable terminals 5 and stop information indicating that the customer does not purchase any commodity and stops shopping are input to the input unit 5001 from the operation unit 53. For example, imaging data obtained by imaging a store entry code, imaging data of a barcode attached to a commodity, and imaging data of a barcode displayed on the checkout device 3 are input to the input unit 5001 from the imaging unit 54.

The input unit 5001 extracts a code symbol such as a barcode or a two-dimensional code from the input imaging data and decodes the code symbol. If the code symbol indicates a commodity code, the input unit 5001 outputs the commodity code to the acquiring unit 5002. If the code symbol indicates a payment code, the input unit 5001 outputs the payment code to the output unit 5005.

The acquiring unit 5002 acquires commodity information from the store server 2 based on the commodity code input from the input unit 5001. Specifically, the acquiring unit 5002 inquires the store server 2 about the commodity code input from the input unit 5001 and acquires commodity information extracted from a commodity master explained below by the store server 2 based on the commodity code. The commodity master may be stored in the memory unit 51. The acquiring unit 5002 may acquire the commodity information from the memory unit 51. The acquiring unit 5002 acquires various kinds of information from the store server 2. For example, the acquiring unit 5002 acquires a check result of a status from the store server 2. The check result of the status is explained in detail in a second embodiment and a third embodiment.

The registering unit 5003 registers the commodity information acquired by the acquiring unit 5002 in the transaction-information storing unit 504 to execute commodity registration. The commodity information may include a commodity code.

The receiving unit 5004 receives stop information indicating that the customer does not purchase any commodity and stops shopping. Specifically, the receiving unit 5004 receives stop information input to the input unit 5001 from the operation unit 53 according to operation of the customer, that is, information to the effect that the customer does not purchase any commodity and stops shopping.

If the receiving unit 5004 receives the stop information, the output unit 5005 outputs information for passage for passing the gate device 4. Specifically, if the receiving unit 5004 receives the stop information, the output unit 5005 outputs the information for passage to the display unit 52. The information for passage is information for causing the display unit 52 to display a store exit code. The output unit 5005 may output the information for passage to the external device such as the checkout device 3. In this case, the store exit code is printed by a printer included in the external device such as the checkout device 3.

The output unit 5005 outputs various kinds of information to the checkout device 3. For example, if a payment code is input from the input unit 5001 or if a transaction information transfer instruction is input from the operation unit 53 via the input unit 5001, the output unit 5005 transmits, to the checkout device 3, the transaction information stored in the transaction-information storing unit 504, the terminal ID, and the number of people information input to the input unit 5001.

Further, the output unit 5005 outputs various kinds of information to the store server 2. For example, the output unit 5005 outputs the terminal ID of the portable terminal 5 and status information indicating operation content of the portable terminal 5 to the store server 2. The status information is registration information indicating that commodity registration is executed in the portable terminal 5, cancellation information indicating that commodity registration is cancelled by the portable terminal 5, or the like.

Exemplary embodiments of the gate device 4 are explained. FIG. 6 is a block diagram illustrating a hardware configuration of the gate device 4. The gate device 4 includes a control unit 40, a memory unit 41, the code reader 44, the display unit 45, the passage sensor 46, the sound output unit 47, and a communication unit 48. The code reader 44 and the display unit 45 are provided in the reading gate 42. The passage sensor 46 and the sound output unit 47 are provided in the sensor gate 43. The control unit 40, the memory unit 41, the code reader 44, the display unit 45, the passage sensor 46, the sound output unit 47, and the communication unit 48 are connected to one another via a bus 49.

The control unit 40 is configured by a computer including a CPU 401, a ROM 402, and a RAM 403. The CPU 401, the ROM 402, and the RAM 403 are connected to one another via the bus 49.

The CPU 401 controls the operation of the entire gate device 4. The ROM 402 stores various programs such as a program used for driving of the CPU 401 and various data. The RAM 403 is used as a work area of the CPU 401. Various programs and various data stored in the ROM 402 and the memory unit 41 are loaded in the RAM 403. The CPU 401 operates according to a control program stored in the ROM 402 or the memory unit 41 and loaded in the RAM 403, whereby the control unit 40 executes various kinds of control processing for the gate device 4.

The memory unit 41 is configured by a storage medium such as a HDD or a flash memory and maintains stored content even if the gate device 4 is turned off. The memory 41 stores a control program 411.

The control program 411 is a program for reading payment completion information, number of people information, and information for passage from a code symbol, a program for detecting the number of people passing the sensor gate 43 based on sensor information of the passage sensor 46, a program for executing error processing, and the like.

The code reader 44 reads information from a code symbol printed on a receipt dispensed by the checkout device 3 or a code symbol displayed on the display unit 52 of the portable terminal 5. The code reader 44 decodes the code symbol recognized by the code reader 44 and reads payment completion information, number of people information, and information for passage. The control unit 40 may decode the code symbol recognized by the code reader 44.

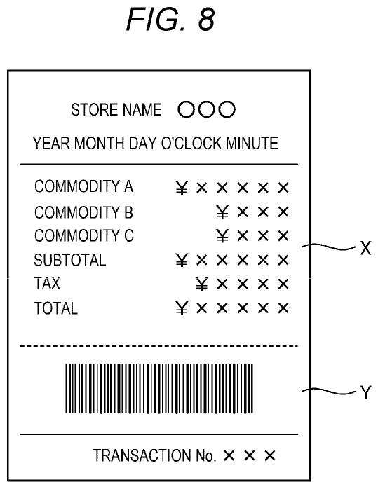

FIG. 8 is a diagram illustrating an exemplary embodiment of a receipt on which a barcode, such as a code symbol, is printed. The receipt includes a transaction information region X and a barcode region Y. In the transaction information region X, commodity names and prices of commodities purchased by the customer, a subtotal amount, which is a total of the prices, a tax amount, a total amount, and the like are printed. In the barcode region Y, a barcode indicating information including payment completion information and number of people information is printed.

The barcode printed in the barcode region Y indicates information such as a transaction No., which is the payment completion information, the number of people information, and the terminal ID.

Referring back to FIG. 6, hardware of the gate device 4 is explained. The display unit 45 is configured by, for example, a liquid crystal panel and displays various kinds of information. The display unit 45 performs, for example, based on the number of people information read by the code reader 44 and the number of people detected by the passage sensor 46, count-down display of the number of people capable of passing the gate device 4.

The passage sensor 46 detects a person who passes the sensor gates 43 and exits the selling floor. As the passage sensor 46, a widely-known sensor such as a sensor that optically detects a person passing the sensor gate 43 can be used.

The sound output unit 47 is configured by a speaker or the like and informs information to the customer passing the gate device 4 and other customers in the checkout area B. For example, if the code reader 44 reads number of people information, the sound output unit 47 informs the number of people indicated by the number of people information to customers around the gate device 4 as the number of passable people.

The communication unit 48 is an interface for communicating with the external devices such as the store server 2, the checkout devices 3, and the portable terminals 5. The control unit 40 is connected to the external devices via the communication unit 48 to be capable of transmitting and receiving information (data) to and from the external devices.

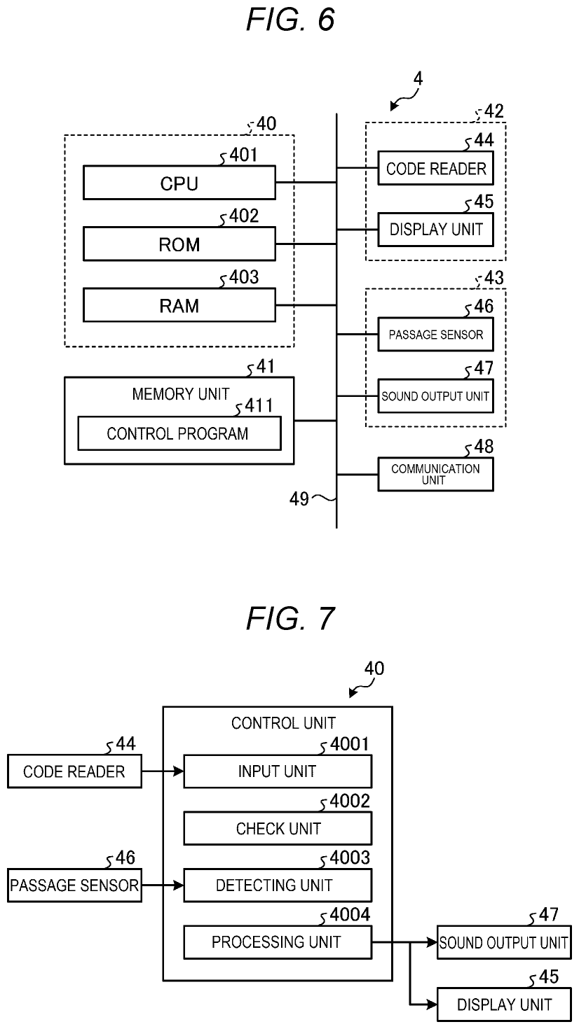

Subsequently, a functional configuration of the control unit 40 of the gate device 4 is explained. FIG. 7 is a block diagram illustrating an exemplary embodiment of main functional components of the control unit 40 of the gate device 4. The CPU 401 operates according to a control program stored in the ROM 402 or the memory unit 41, whereby the control unit 40 functions as an input unit 4001, a check unit 4002, a detecting unit 4003, and a processing unit 4004. These functions may be configured by hardware such as dedicated circuits.

Information for passage output by the output unit 5005 of the portable terminal 5 is input to the input unit 4001. Specifically, the information for passage read by the code reader 44 from the store exit code displayed on the display unit 52 of the portable terminal 5 is input to the input unit 4001 from the code reader 44. The number of people information, the terminal ID, and the like included in the store exit code are also input to the input unit 4001. The payment completion information, the number of people information, the terminal ID, and the like read by the code reader 44 from the barcode printed on the receipt are input to the input unit 4001.

The check unit 4002 checks whether the payment completion information input to the input unit 4001 is correct. For example, the check unit 4002 inquires the store server 2 about whether the transaction No. input to the input unit 4001 as the payment completion information is a transaction No. concerning a transaction in the store to check the transaction completion information. The check unit 4002 checks based on the terminal ID input to the input unit 4001 together with the information for passage that commodity registration is not performed in the portable terminal 5 specified by the terminal ID. In other words, the check unit 4002 checks that the portable terminal 5 displaying the store exit code indicating the information for passage is the portable terminal 5 in which commodity registration is not performed, that is, the portable terminal 5 of a customer who does not purchase any commodity. For example, the check unit 4002 inquires the store server 2, which stores the terminal ID and an operation status in association with each other, to check that commodity registration is not performed in the portable terminal 5 that displays the store exit code indicating the information for passage. The gate device 4 does not always need to include the check unit 4002. However, the gate device 4 can improve an effect of suppressing a fraudulent store exit by including the check unit 4002.

The control unit 4003 detects the number of customers passing the gate device 4. Specifically, the detecting unit 4003 detects, based on an output of the passage sensor 46, the number of people passing the gate device 4 and existing the sales floor.

If the information for passage is input to the input unit 4001, the processing unit 4004 allows passage of the customer without executing error processing. Specifically, if the information for passage is input to the input unit 4001, the processing unit 4004 allows a normal exit from the selling floor without executing error processing such as informing for urging the reading gate 42 to read information for a normal exit. The processing unit 4004 also allows the normal exit from the selling floor if the payment completion information is input to the input unit 4001. If the customer attempts to pass the sensor gate 43 in a state in which neither the information for passage nor the payment completion information is input to the input unit 4001, the processing unit 4004 causes the display unit 45 or the sound output unit 47 to output a message for urging the customer to read the information for a normal exit and informs the customer. The informing is an example of the error processing.

The processing unit 4004 causes the display unit 45 or the sound output unit 47 to output, as the number of passable people with respect to the payment completion information or the information for passage input to the input unit 4001, the number of people indicated by the number of people information input to the input unit 4001. Further, the processing unit 4004 executes the same error processing as the error processing explained above if the number of passing people detected by the detecting unit 4003 as the number of passing people with respect to the payment completion information or the information for passage exceeds the number of people indicated by the number of people information.

An exemplary embodiment of the store server 2 is explained. FIG. 9 is a block diagram illustrating an exemplary hardware configuration of the store server 2. The store server 2 includes a control unit 20, a memory unit 21, a display unit 22, an operation unit 23, and a communication unit 24. The control unit 20, the memory unit 21, the display unit 22, the operation unit 23, and the communication unit 24 are connected to one another via a bus 25.

The control unit 20 is configured by a computer including a CPU 201, a ROM 202, and a RAM 203. The CPU 201, the ROM 202, and the RAM 203 are connected to one another via the bus 25.

The CPU 201 controls the operation of the entire store server 2. The ROM 202 stores various programs such as a program used for driving of the CPU 201 and various data. The RAM 203 is used as a work area of the CPU 201. Various programs and various data stored in the ROM 202 and the memory unit 21 are loaded in the RAM 203. The CPU 201 operates according to a control program stored in the ROM 202 or the memory unit 21 and loaded in the RAM 203, whereby the control unit 20 executes various kinds of control processing of the store server 2.

The memory unit 21 is configured by a storage medium such as HDD or a flash memory and maintains stored content even if the store server 2 is turned off. The memory unit 21 stores a control program 211, a commodity master 212, a status management file 213, a processing master 214, and a customer fraudulence degree management file 215.

The control program 211 is a program for managing a status of the customer, a program for managing a fraudulence degree of the customer based on the status of the customer, and the like.

The commodity master 212 is a master file in which information concerning commodities sold in the store is stored. In the commodity master 212, commodity codes for identifying commodities and commodity information such as commodity names and prices are associated. Since the commodities sold in the store change every day, the commodity master 212 is updated as appropriate.

The status management file 213 is a file for managing a status of the customer entering the selling floor. The status management file 213 is updated every time the store server 2 acquires status information indicating operation content of the customer from the portable terminal 5, the checkout device 3, and the gate device 4. FIG. 10 is a diagram illustrating a data configuration of the status management file 213. In the status management file 213, various kinds of information indicating a terminal ID, a store entry, registration, settlement, gate reading within time are associated. In the status management file 213, other information may be associated in addition to the information described above. For example, in the status management file 213, a shopping stop flag recording presence or absence of operation for a shopping stop by the customer may be associated with the information described above.

In the item of the terminal ID, a terminal ID for identifying the portable terminal 5 carried by the customer is registered. If the customer reads the store entry code displayed on the store-entry-code display unit AA with the portable terminal 5, the portable terminal 5 transmits the terminal ID to the store server 2. The store server 2 registers the received terminal ID. The terminal ID may be registered in advance based on information from the customer.

In the item of the store entry, information indicating whether the customer enters the store is registered. In the item of the store entry, “finished” is registered at timing when the terminal ID is registered. If the terminal ID is registered in advance, “finished” is registered in the item of the store entry at timing when the customer enters the selling floor and the store server 2 receives the terminal ID from the portable terminal 5.

In the item of the registration, information indicating whether the portable terminal 5 is in a state in which effective commodity registration is performed in the portable terminal 5 is registered. The effective commodity registration is commodity registration not cancelled. In the state in which the effective commodity registration is performed in the portable terminal 5, in other words, a state in which commodity information is registered in the transaction-information storing unit 504 of the portable terminal 5, “finished” is registered in the item of the registration. For example, if the customer performs commodity registration for one commodity, the portable terminal 5 transmits, to the store server 2, registration information indicating that the commodity registration is performed. The store server 2 registers “finished” in the item of the registration based on the received registration information. If the customer performs cancellation of the commodity registration, the portable terminal 5 transmits, to the store server 2, cancellation information indicating that the commodity registration is cancelled. The store server 2 rewrites the item of the registration from “finished” to “unfinished” based on the received cancellation information. By also acquiring a commodity code of a target commodity of the registration information and the cancellation information from the portable terminal 5, the store server 2 can determine whether all commodity registrations executed by the portable terminal 5 are cancelled. Even if the cancellation information is received, if not all of the commodity registrations executed by the portable terminal 5 are cancelled, the store server 2 does not rewrite the item of the registration from “finished” to “unfinished”. The status management file 213 is an example of a commodity-registration-information storing unit in which commodity registration information indicating presence or absence of a commodity registered based on operation of the customer is stored.

In the item of the settlement, information indicating whether settlement for the transaction information stored in the transaction-information storing unit 504 of the portable terminal 5 is performed. If transferring the transaction information stored in the transaction-information storing unit 504 and the terminal ID to the checkout device 3, the portable terminal 5 transmits settlement processing information indicating that the settlement is performed to the store server 2 together with the terminal ID. The store server 2 registers “finished” in the item of the settlement based on the received settlement processing information. The settlement processing information received by the store server 2 may be transmitted from the checkout device 3 at a point in time when checkout processing is executed in the checkout device 3.

In the item of the gate reading within time, information indicating whether normal reading of the payment completion information or the information for passage is performed by the gate device 4 within a predetermined time after the customer enters the selling floor is registered. The predetermined time is a predicted longest time of the customer staying in the selling floor and is set by the store. If the gate device 4 reads the terminal ID and the payment completion information from the barcode of the receipt or reads the terminal ID and the information for passage from the portable terminal 5, the gate device 4 transmits reading processing information indicating that normal reading is performed to the store server 2 together with the terminal ID. The store server 2 registers “finished” in the item of the gate reading within time based on the received reading processing information.

The information registered in the items of the store entry, the registration, the settlement, and the gate reading within time described above can be considered status information indicating statuses of the customer in the selling floor.

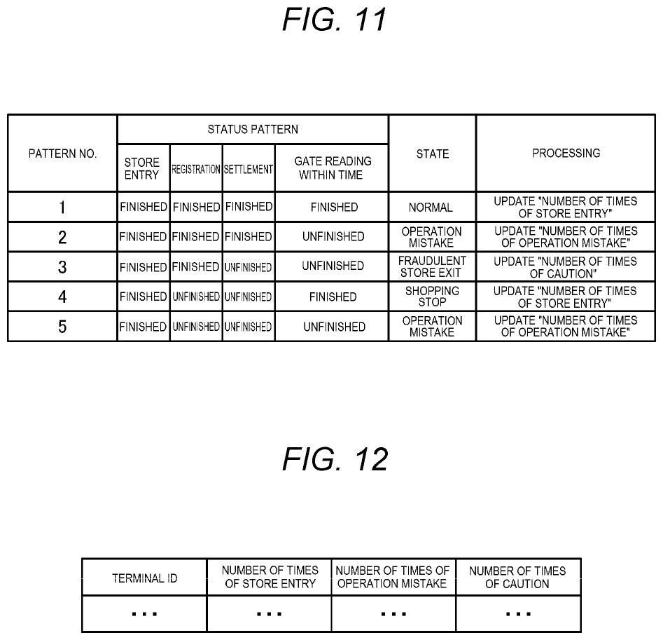

The processing master 214 is a master file deciding processing contents for updating the customer fraudulence degree management file according to status patterns of the customer. FIG. 11 is a diagram illustrating an exemplary data configuration of the processing master 214. In the processing master 214, individual kinds of information indicating a pattern No., a store entry, registration, settlement, gate reading within time, a state, and processing are associated.

In the item of the pattern No., a number for specifying a status pattern of the customer in the selling floor is registered.

Information registered in items of the store entry, the registration, the settlement, and the gate reading within time indicating the status patterns is as explained above. Therefore, redundant explanation of the information is omitted.

In the item of the state, information indicating a state of the customer assumed by a status pattern corresponding to the item is registered. In a pattern No. 1, all of the store entry, the registration, the settlement, and the gate reading within time are “finished”. Since it is assumed that the customer performed commodity registration after the store entry, caused the gate device 4 to read the payment completion information after finishing payment, and exited the selling floor, the state is set as “normal”. In a pattern No. 2, since it is assumed that payment is completed but the customer did not correctly exit from the gate device 4 (for example, exited from the selling floor entrance I), the state is set as “operation mistake”.

In a pattern No. 3, since it is assumed that the customer did not pay for a registered commodity and did not correctly exit from the gate device 4, the state is set as “fraudulent store exit”.

In a pattern No. 4, since it is assumed that the customer entered the selling floor but did not perform commodity registration or cancelled all commodity registrations and, thereafter, caused the gate device 4 to read the information for passage and exited the selling floor, the state is set as “shopping stop”. In a pattern No. 5, since it is assumed that the customer entered the selling floor but did not perform commodity registration or cancelled all commodity registrations and, thereafter, did not correctly exit from the gate device 4, the state is set as “operation mistake”.

In the item of the processing, information indicating content for updating the customer fraudulence degree management file 215 according to a status pattern corresponding to the item is registered. In the pattern No. 1 and the pattern No. 4, a fraudulent act of the customer is not recognized and the customer is recognized as performing correct operation. In this case, “the number of times of store entry” of the customer fraudulence degree management file 215 is added and updated. In the pattern No. 2 and the pattern No. 5, although a fraudulent act of the customer is not recognized, a point not matching the operation of the sales management system 1 is recognized in operation or an action of the customer. In this case, “the number of times of operation mistake” of the customer fraudulence degree management file 215 is added and updated. In the pattern No. 3, a fraudulent act of the customer is doubted. In this case, “the number of times of caution” of the customer fraudulence degree management file 215 is added and updated.

The customer fraudulence degree management file 215 is a file for managing a fraudulence degree of the customer, in other words, possibility of a fraud according to a status pattern of the customer. The customer fraudulence degree management file 215 is updated every time the customer visits the store. FIG. 12 is a diagram illustrating an exemplary data configuration of the customer fraudulence degree management file 215. In the customer fraudulence degree management file 215, individual kinds of information indicating a terminal ID, the number of times of store entry, the number of times of operation mistake, and the number of times of caution are associated.

In the item of the terminal ID, the terminal ID for identifying the portable terminal 5 carried by the customer is registered. In the item of the number of times of store entry, information indicating the number of times of store entry in which a fraudulent act is not doubted and the customer is recognized as performing correct operation is registered. In the item of the number of times of operation mistake, information indicating the number of times of shopping in which a fraudulent act is not recognized but the customer is recognized as not performing correct operation or a correct action is registered. In the item of the number of times of caution, information indicating the number of times of shopping in which a fraudulent act is doubted is registered.

By managing the fraudulence degree of the customer using the customer fraudulence degree management file 215, the store can take various measures against frauds of customers. For example, if the number of times of caution of a specific terminal ID exceeds a fixed value, it is possible to issue an instruction to strengthen fraud monitoring to store clerks in the store if a customer carrying the portable terminal 5 identified by the terminal ID visits the store. If the number of times of caution of a specific terminal ID exceeds the number of times of setting set to the fixed number of times or more, it is possible to take measures for, for example, refusing shopping of a customer carrying the portable terminal 5 identified by the terminal ID.

A system that leaves operation of commodity registration and payment to a customer, in other words, a system in which a customer does shopping without intervention of a store clerk is based on trust in the customer. However, on the other hand, it is also true that a fraudulent act of a customer may easily occur. If monitoring against frauds of customers is intensified more than necessary by, for example, setting a large number of security cameras and stationing a large number of watchmen, there is a concern that customers feel discomfort and the number of customers decreases. With the management of the customer fraudulence degree based on the status of the customer in this exemplary, non-limiting embodiment, it is possible to take measures against frauds of customers while suppressing discomfort of the customers.

Referring back to FIG. 9, an exemplary hardware configuration of the store server 2 is explained. The display unit 22 is configured by, for example, a liquid crystal panel and displays various kinds of information. The operation unit 23 is configured by a keyboard, a touch panel, or the like and is operated by the store clerk. The communication unit 24 is an interface for communicating with the external devices such as the checkout devices 3, the gate devices 4, and the portable terminals 5. The control unit 20 is connected to the external devices via the communication unit 24 to be capable of transmitting and receiving information (data) to and from the external devices.

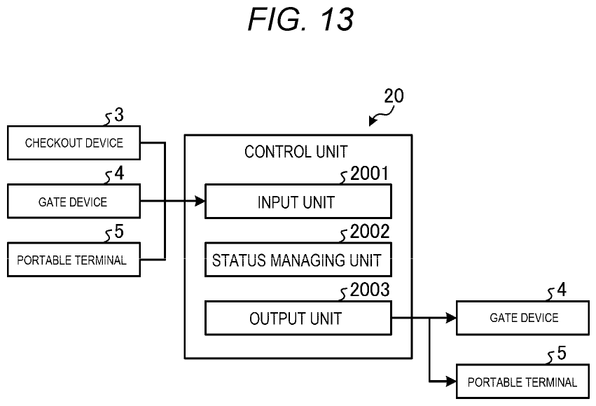

Subsequently, a functional configuration of the control unit 20 of the store server 2 is explained. FIG. 13 is a block diagram illustrating exemplary main functional components of the control unit 20 of the store server 2. The CPU 201 operates according to a control program stored in the ROM 202 or the memory unit 21, whereby the control unit 20 functions as an input unit 2001, a status managing unit 2002, and an output unit 2003. These functions maybe configured by hardware such as dedicated circuits.

Various kinds of information are input to the input unit 2001 from the checkout devices 3, the gate devices 4, and the portable terminals 5. For example, commodity information of a commodity for which checkout processing is executed and settlement information concerning a settlement method and the like are input to the input unit 2001 from the checkout device 3. If the gate device 4 reads the payment completion information and the information for passage, a terminal ID and reading processing information indicating that normal reading is performed are input to the input unit 2001 from the gate device 4. Further, the terminal ID and status information indicating operation content of the customer are input to the input unit 2001 from the portable terminal 5. The status information is registration information indicating that commodity registration operation is performed by the portable terminal 5, cancellation information indicating that commodity registration is cancelled, settlement processing information indicating that transaction information is transmitted to the checkout device 3, and the like.

The status managing unit 2002 manages a status in the selling floor for each portable terminal 5, in other words, for each customer. For example, the status managing unit 2002 updates the status management file 213 based on status information input to the input unit 2001. The status managing unit 2002 updates the customer fraudulence management file 215 based on information registered in the status management file 213.

The output unit 2003 outputs various kinds of information to the gate devices 4, the portable terminals 5, and the like. For example, the output unit 2003 outputs a check result of the status to the gate devices 4 and the portable terminals 5. The check result of the status is explained in detail in the second embodiment and the third embodiment.

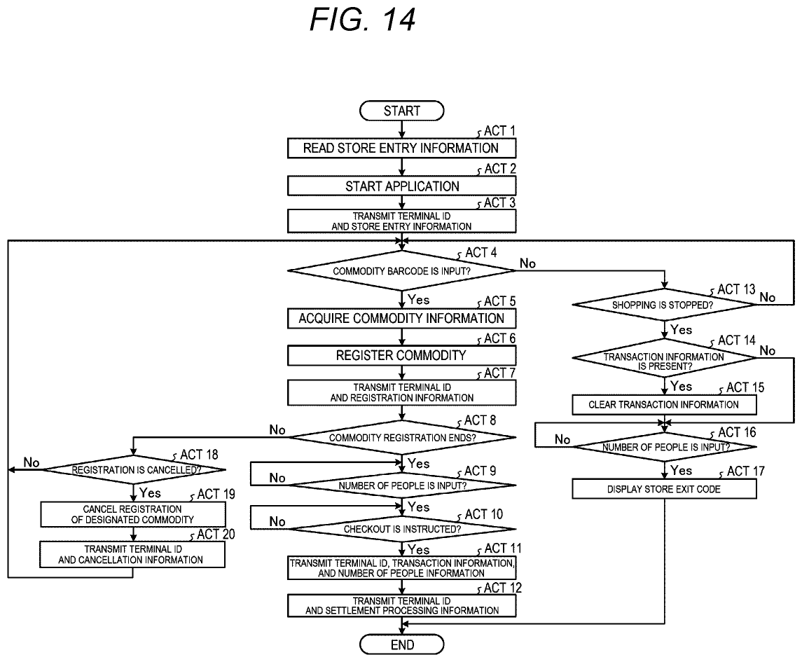

Processing executed by the portable terminal 5 in this embodiment is explained. FIG. 14 is a flowchart illustrating a flow of the processing by the control unit 50 of the portable terminal 5 in an exemplary, non-limiting embodiment.

First, if the customer images the store entry code of the store-entry-code display unit AA with the portable terminal 5, the input unit 5001 reads, based on input imaging data, store entry information indicating that the customer enters the store (Act 1). If the store entry information is read, the control unit 50 starts the application program for shopping (Act 2). Subsequently, the output unit 5005 transmits the terminal ID and the store entry information to the store server 2 (Act 3).

Thereafter, the control unit 50 determines whether a commodity barcode indicating a commodity code is input to the input unit 5001 (Act 4). If the commodity barcode is input (Y in Act 4), the acquiring unit 5002 acquires commodity information from the store server 2 based on the commodity code read by the input unit 5001 (Act 5). Specifically, the acquiring unit 5002 transmits the commodity code and a request for the commodity information corresponding to the commodity code to the store server 2 and receives the commodity information from the store server 2.

Subsequently, the registering unit 5003 registers (stores) the commodity information acquired by the acquiring unit 5002 in the transaction-information storing unit 504 to execute commodity registration (Act 6). The output unit 5005 transmits the terminal ID and the registration information to the store server 2 (Act 7). The control unit 50 determines whether information to the effect that the commodity registration is ended is input to the input unit 5001 (Act 8). If the information to the effect that the commodity registration is ended is input (Y in Act 8), the control unit 50 determines whether number of people information indicating the number of customers is input to the input unit 5001 (Act 9). If the number of people information is not input (N in Act 9), the control unit 50 returns to the processing in Act 9 and stays on standby. If the number of people information is input (Y in Act 9), the control unit 50 determines whether a checkout instruction is input to the input unit 5001 (Act 10). If the checkout instruction is not input (N in Act 10), the control unit 50 returns to the processing in Act 10 and stays on standby.

If the checkout instruction is input (Y in Act 10), the output unit 5005 outputs, to the checkout device 3, the terminal ID, the transaction information stored in the transaction-information storing unit 504, and the number of people information input to the input unit 5001 (Act 11) and subsequently transmits the terminal ID and settlement processing information indicating that settlement is finished to the store server 2 (Act 12). At this time, the transaction information stored in the transaction-information storing unit 504 is cleared. The control unit 50 ends the processing. If the customer finishes payment in the checkout device 3, the checkout device 3 dispenses a receipt on which a code symbol indicating that the payment is completed is printed. The customer can normally exit the selling floor by causing the gate device 4 to read the code symbol printed on the receipt. If the customer finishes payment in the checkout device 3, the portable terminal 5 may be able to display, based on an output from the checkout device 3, a code symbol indicating that the payment is completed. The code symbol may be displayed in a form in which the code symbol is included in an electronic receipt or may be displayed independently from the transaction information.

If the commodity barcode is not input in the processing in Act 4 (N in Act 4), the control unit 50 determines whether the receiving unit 5004 receives stop information indicating a shopping stop (Act 13). If not receiving the stop information (N in Act 13), the control unit 50 returns to the processing in Act 4. If receiving the stop information (Y in Act 13), the control unit 50 determines whether transaction information is stored in the transaction-information storing unit 504 (Act 14). If transaction information is stored (Y in Act 14), the control unit 50 clears the transaction information stored in the transaction-information storing unit 504 (Act 15) and determines whether number of people information is input to the input unit 5001 (Act 16). Consequently, if the receiving unit 5004 receives the stop information, information registered at that point in time is cleared. If transaction information is not stored in the processing in Act 14 (N in Act 14), the control unit 50 skips the processing in Act 15 and shifts to the processing in Act 16.

If number of people information is not input (N in Act 16), the control unit 50 returns to the processing in Act 16 and stays on standby. If number of people information is input (Y in Act 16), the control unit 50 causes the display unit 52 to display the store exit code (Act 17) and ends the processing. In this embodiment, if the receiving unit 5004 receives the stop information, the control unit 50 clears the transaction information stored in the transaction-information storing unit 504 at that point in time. However, the control unit 50 may display the store exit code without clearing the transaction information.

If the commodity registration is not ended in the processing in Act 8 (N in Act 8), the control unit 50 determines whether information to the effect that already executed commodity registration is cancelled is input to the input unit 5001 (Act 18). If the information is not input (N in Act 18), the control unit 50 returns to the processing in Act 4. If the information to the effect that the commodity registration is cancelled is input (Y in Act 18), the registering unit 5003 cancels commodity registration of a commodity designated by the information (Act 19). Subsequently, the output unit 5005 transmits the terminal ID and the cancellation information to the store server 2 (Act 20). At this time, the output unit 5005 transmits a commodity code of the commodity registration cancellation target to the store server 2 as well. The control unit 50 shifts to the processing in Act 4.

According to the exemplary processing explained above, the portable terminal 5 functions as the commodity registration device and, if the customer does not purchase any commodity and stops shopping, displays the store exit code for passing the gate device 4 and normally exiting. The portable terminal 5 transmits the status information such as the registration information, the cancellation information, and the settlement processing information to the store server 2.

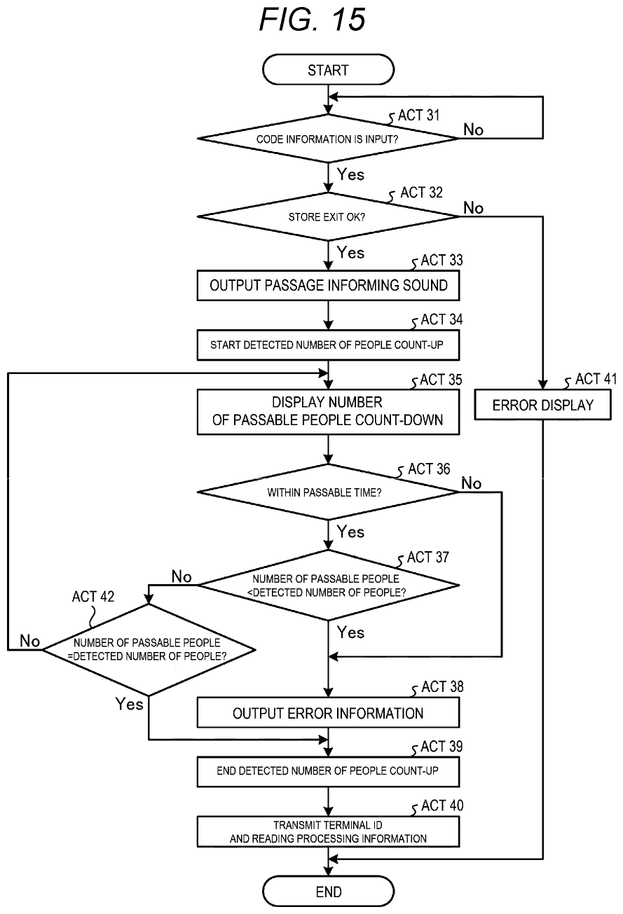

Subsequently, processing executed in the gate device 4 is explained. FIG. 15 is a flowchart illustrating a flow of processing by the control unit 40 of the gate device 4 in an exemplary embodiment.

The control unit 40 determines whether code information is input to the input unit 4001 (Act 31). If code information is not input (N in Act 31), the control unit 40 returns to the processing in Act 31 and stays on standby. If code information is input to the input unit 4001 (Y in Act 31), the check unit 4002 checks whether the input code information is information of store exit OK for allowing normal exit of the customer (Act 32). Specifically, the check unit 4002 determines whether the code information input to the input unit 4001 is the payment completion information or the information for passage.

If the code information input to the input unit 4001 is the information of store exit OK (Y in Act 32), the processing unit 4004 causes the sound output unit 47 to output sound for informing passage of the gate device 4 (Act 33). Subsequently, the detecting unit 4003 starts count-up of the number of people passing the sensor gate 43 (Act 34). The processing unit 4004 controls the display unit 45 to perform count-down display of the number of passable people based on number of people information input to the input unit 4001 and the number of passing people detected by the detecting unit 4003 (Act 35).

Subsequently, the control unit 40 determines whether it is within a passable time of the customer whose payment completion information and information for passage are read by the code reader 44, in other words, whether it is within a predetermined time from the sound output of the passage information in the processing in Act 33 (Act 36). If it is within the passable time (Y in Act 36), the control unit 40 determines whether the number of people detected by the detecting unit 4003 exceeds the number of passable people (Act 37).

If the number of people detected by the detecting unit 4003 exceeds the number of passable people (Y in Act 37), the processing unit 4004 outputs error information to the sound output unit 47 (Act 38). Consequently, the sound output unit 47 outputs an error message such as “please hold the barcode over the barcode reader”. Subsequently, the detecting unit 4003 ends the count-up of the number of detected people (Act 39). The control unit 40 transmits the terminal ID read by the code reader 44 and reading processing information indicating that normal reading is performed to the store server 2 together with the payment completion information or the information for passage (Act 40) and ends the processing.

If the payment completion information or the information for passage is not included in the code information input to the input unit 4001 in the processing in Act 32 (N in Act 32), the processing unit 4004 controls the display unit 45 to perform error display (Act 41). In the error display, display such as “please hold the barcode of the receipt dispensed by payment over the code reader” is performed. The control unit 40 ends the processing.

If it is not within the passable time in the processing in Act 36 (N in Act 36), the control unit 40 skips the processing in Act 37 and shifts to the processing in Act 38. If the number of people detected by the detecting unit 4003 does not exceed the number of passable people in the processing in Act 37 (N in Act 37), the control unit 40 determines whether the number of people detected by the detecting unit 4003 is the same as the number of passable people (Act 42). If the number of detected people and the number of passable people are the same (Y in Act 42), the control unit 40 shifts to the processing in Act 39. If the number of detected people and the number of passable people are not the same (N in Act 42), the control unit 40 returns to the processing in Act 35.

According to the exemplary processing explained above, the gate device 4 allows a customer completing payment to pass the gate device 4 and normally exit the selling floor and, if a customer not completing payment attempts to pass the gate device 4, executes the error processing and suppresses a fraudulent exit of the customer from the selling floor. The gate device 4 allows a customer stopping shopping and not purchasing any commodity to pass the gate device 4 and normally exit the selling floor.

With the sales management system 1 in the first exemplary embodiment, it is possible to effectively suppress a fraudulent store exit of a customer entering the selling floor. A customer not purchasing any commodity can normally exit the selling floor. Therefore, the sales management system 1 in the first exemplary embodiment has an advantage that it is possible to secure convenience of a customer while suppressing a fraudulent act of the customer.

### Second Embodiment

A second exemplary embodiment is explained. The second exemplary embodiment is different from the first embodiment in that, if the portable terminal 5 displays the store exit code, the portable terminal 5 checks based on an operation status of the customer managed by the store server 2 that commodity registration is not performed by the portable terminal 5 or all commodity registrations are cancelled. In the following explanation, explanation is sometimes omitted about the same components and functions as the components and the functions in the first embodiment. This is to avoid the following explanation becoming redundant and facilitate understanding of those skilled in the art.

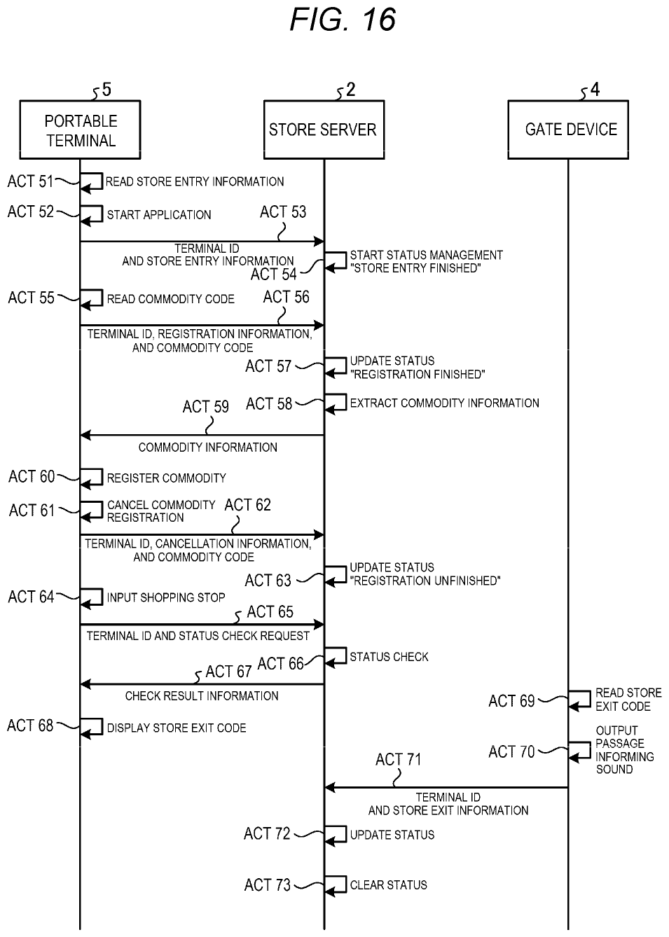

Operation by the sales management system 1 in the second embodiment is explained. FIG. 16 is a sequence chart illustrating an exemplary flow of operation in which a customer who performs commodity registration with the portable terminal 5 and, thereafter, cancels the commodity registration and causes the portable terminal 5 to display the store exit code, passes the gate 4 and normally exits the selling floor.

First, the customer enters the store and the portable terminal 5 reads store entry information from the store entry code displayed on the store-entry-code display unit AA (Act 51). The portable terminal 5 starts the application program for shopping (Act 52) and transmits the terminal ID and the store entry information to the store server 2 (Act 53). The store server 2 starts status management based on the received terminal ID and the received store entry information (Act 54). Specifically, the store server 2 registers the received terminal ID in the status management file 213 and registers “finished” in the item of the store entry.

Subsequently, if reading a commodity code (Act 55), the portable terminal 5 transmits the terminal ID, registration information indicating that commodity registration is performed, and the read commodity code to the store server 2 (Act 56). The store server 2 registers “finished” in the item of the registration corresponding to the received terminal ID in the status management file 213 and updates the status management file 213 (Act 57). The store server 2 extracts commodity information corresponding to the received commodity code with reference to the commodity master 212 (Act 58) and transmits the extracted commodity information to the portable terminal 5 (Act 59).

The portable terminal 5 executes commodity registration based on the received commodity information (Act 60). If the customer cancels purchase of a registered commodity because of some reason, information indicating the cancellation of the commodity registration is input to the portable terminal 5 (Act 61). The portable terminal 5 transmits the terminal ID, the cancellation information, and the commodity code of the commodity registration cancellation target commodity to the store server 2 (Act 62). The store server 2 rewrites the item of the registration corresponding to the received terminal ID in the status management file 213 from “finished” to “unfinished” according to necessity and updates the status management file 213 (Act 63).

Thereafter, if stop information to the effect that shopping is stopped is input (Act 64), the portable terminal 5 transmits the terminal ID and a status check request to the store server 2 (Act 65). The status check request is a request for, if the stop information is input to the portable terminal 5, requesting the store server 2 to check whether commodity registration is not executed by the portable terminal 5 after the customer enters the selling floor or whether executed all commodity registrations are cancelled. The portable terminal 5 receives a check result to thereby prevent the store exit code from being displayed in a state in which the commodity registration is not cancelled and the commodity is not returned. Consequently, it is possible to further suppress a fraudulent act of the customer. The check about whether a registered commodity is absent may be performed according to whether commodity information is stored in the transaction-information storing unit 504. In this case, the transaction-information storing unit 504 can be considered an example of a commodity-registration-information storing unit in which commodity registration information indicating presence or absence of a commodity registered is stored based on operation of the customer.

The store server 2 performs a status check (Act 66) and transmits a check result to the portable terminal 5 (Act 67). If the shopping stop flag recording presence or absence of operation for a shopping stop explained above is set in the status management file 213, the store server 2 may perform the status check based on registration information of the shopping stop flag. In this case, if the shopping stop is input to the portable terminal 5, the customer is capable of performing a normal exit. If the check result indicates that a registered commodity is absent, the portable terminal 5 displays the store exit code (Act 68). That is, if receiving the stop information, the portable terminal 5 displays the store exit code on condition that a registered commodity is absent.

If the store exit code is displayed on the portable terminal 5, the customer causes the gate device 4 to read the store exit code (Act 69). The gate device 4 reading the store exit code outputs passage information with sound (Act 70) and transmits the terminal ID and store exist information to the store server 2 (Act 71). The store server 2 registers “finished” in the item of the within-time gate passage reading corresponding to the received terminal ID in the status management file 213 and updates the status management file 213 and adds the number of times of store entry corresponding to the terminal ID in the customer fraudulence degree management file 215 and updates the customer fraudulence degree management file 215 (Act 72). Subsequently, the store server 2 clears individual kinds of status information corresponding to the received terminal ID in the status management file 213 (Act 73).

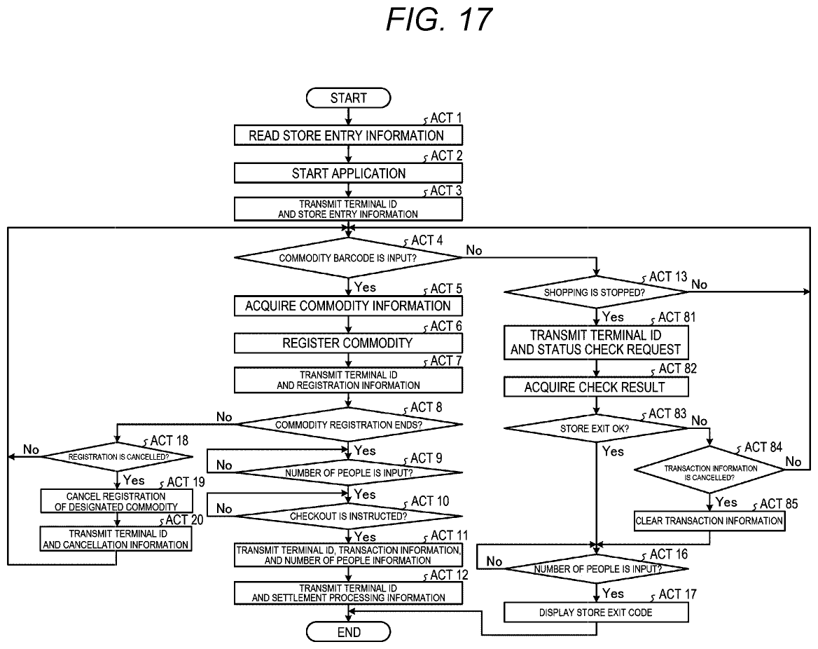

Processing executed by the portable terminal 5 in this exemplary embodiment is explained. FIG. 17 is a flowchart illustrating an exemplary flow of processing by the control unit 50 of the portable terminal 5 in this embodiment. Since many kinds of processing are the same as those in the first embodiment, the same kinds of processing as those in the first embodiment are denoted by the same reference signs as the reference signs in FIG. 14 and explanation of the processing is sometimes omitted.

If the receiving unit 5004 receives the stop information (Y in Act 13), the output unit 5005 transmits the terminal ID and a status check request to the store server 2 (Act 81). The acquiring unit 5002 acquires a check result from the store server 2 as a response to the status check request (Act 82).

The control unit 50 determines whether the check result indicates store exit OK (Act 83). In other words, the control unit 50 determines whether the check result indicates that a registered commodity is absent in the portable terminal 5. If the check result indicates store exit OK (Y in Act 83), the control unit 50 shifts to processing in Act 16. If the check result does not indicate store exit OK (N in Act 83), the control unit 50 determines whether information indicating transaction information cancellation is input, in other words, whether an input to the effect that shopping is stopped and information registered to that point is deleted is performed by the customer (Act 84). If the information indicating the transaction information cancellation is input (Y in Act 84), the control unit 50 clears the transaction information stored in the transaction-information storing unit 504 (Act 85) and shifts to the processing in Act 16. Consequently, if the customer stopping the shopping forgets to cancel the registered information, it is possible to collectively clear the transaction information stored in the transaction-information storing unit 504. If the check result does not indicate store exit OK in the processing in Act 83 (N in Act 83), the control unit 50 may shift to processing in Act 18. If the information indicating the transaction information cancellation is not input (N in Act 84), the control unit 50 returns to the processing in Act 4.

According to the exemplary processing explained above, if the receiving unit 5004 receives the stop information, the output unit 5005 refers to the commodity-registration-information storing unit (the status management file 213) and outputs the information for passage on condition that a registered commodity is absent.

With the sales management system 1 in the second embodiment, if displaying the store exit code, the portable terminal 5 performs the status check and displays the store exit code on condition that a registered commodity is absent. Therefore, the sales management system 1 in the second embodiment has an advantage that a fraudulent store exit of the customer can be further suppressed in addition to the advantage of the sales management system 1 in the first embodiment.

### Third Embodiment

A third exemplary embodiment is explained. The third embodiment is different from the first embodiment and the second embodiment in that, if the gate device 4 reads the store exit code displayed by the portable terminal 5, the gate device 4 checks that commodity registration is not performed by the portable terminal 5 or all commodity registrations are cancelled. In the following exemplary, non-limiting explanation, explanation is sometimes omitted about the same components and functions as the components and the functions in the first embodiment or the second embodiment. This is to avoid the following explanation becoming unnecessarily redundant and facilitate understanding of those skilled in the art.

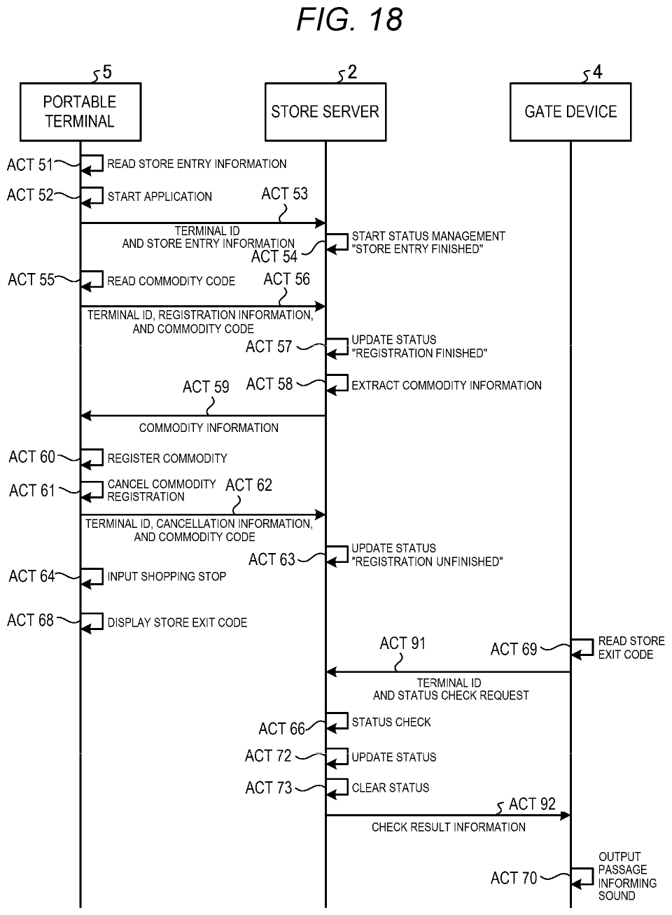

Operation by the sales management system 1 in the third exemplary embodiment is explained. FIG. 18 is a sequence chart illustrating exemplary an flow of operation in which the customer performing commodity registration with the portable terminal 5 and, thereafter, cancelling the commodity registration and causing the portable terminal 5 to display the store exit code passes the gate device 4 and normally exits the selling floor. Since many kinds of processing are the same as those in the second embodiment, the same kinds of processing as those in the second embodiment are denoted by the same reference signs as the reference signs in FIG. 16 and explanation of the processing is sometimes omitted.

If stop information to the effect that shopping is stopped is input (Act 64), the portable terminal 5 displays the store exit code without performing a status check (Act 68). If reading the store exit code displayed on the portable terminal 5 (Act 69), the gate device 4 transmits the terminal ID and a status check request to the store server 2 (Act 91).

The store server 2 performs a status check (Act 66) and executes status update (Act 72). That is, the store server 2 registers “finished” in the item of the within-time gate passage reading corresponding to the received terminal ID in the status management file 213 and updates the status management file 213. The store server 2 adds the number of times of store entry corresponding to the terminal ID in the customer fraudulence degree management file 215 and updates the customer fraudulence degree management file 215. Subsequently, the store server 2 clears individual kinds of status information corresponding to the received terminal ID in the status management file 213 (Act 73) and transmits a check result to the gate device 4 (Act 92).

If the check result indicates that a registered commodity is absent, the gate device 4 outputs passage information with sound (Act 70).

Together with the status check, with a method explained below, the store server 2 may check that a commodity is absent in the shopping cart SC of the customer who stops the shopping.

For example, a sensor that detects that a commodity is not stored in the shopping cart SC and a control unit are provided. The sensor can be, for example, a camera that captures an image of a storing section of the shopping cart SC or a weight sensor that detects the weight of commodities stored in the storing section. The sensor and the control unit are communicably connected to the store server 2 via a wireless LAN or the like.

If receiving a status check request in Act 91 in FIG. 18, the store server 2 acquires sensor information from the sensor of the shopping cart SC. If the acquired sensor information is predetermined information and, as a result of a status check, commodity registration is not performed by the portable terminal 5, in processing in Act 92, the store server 2 outputs information indicating store exit OK to the gate device 4. The predetermined information is information indicating that a commodity is not stored in the storing section of the shopping cart SC.

By adopting such an exemplary configuration, it is possible to more surely suppress a fraudulent act of the customer. This is because, in the embodiment explained above, although, according to the cancellation of the commodity registration, it is regarded that the registered commodity is returned from the shopping cart SC to the selling floor and the normal exit is admitted, in addition to this, the normal exit is admitted after confirming that the commodity is actually returned.

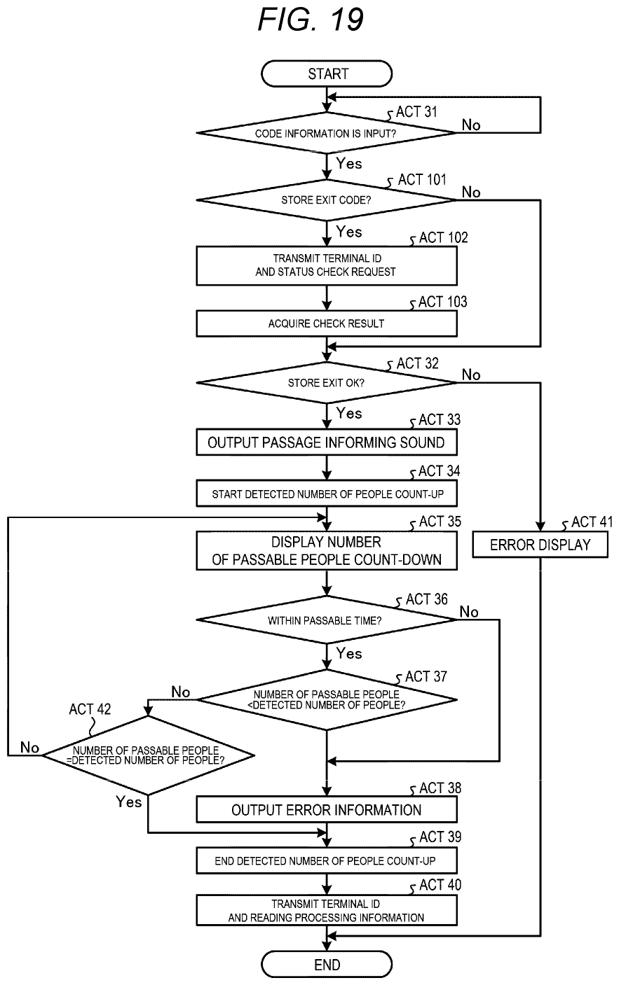

Processing executed in the gate device 4 in this exemplary embodiment is explained. FIG. 19 is a flowchart illustrating an exemplary flow of processing by the control unit 40 of the gate device 4 in this embodiment. Since many kinds of processing are the same as those in the first embodiment, the same kinds of processing as those in the first embodiment are denoted by the same reference signs as the reference signs in FIG. 15 and explanation of the processing is sometimes omitted.

If code information is input to the input unit 4001 (Y in Act 31), the control unit 40 determines whether the input code information is the store exit code (Act 101). If the code information is the store exit code (Y in Act 101), the processing unit 4004 transmits the terminal ID included in the store exit code and a status check request to the store server 2.

The control unit 40 acquires a check result from the store server 2 as a response to the status check request (Act 103) and shifts to processing in Act 32. The processing in Act 32 and subsequent acts is the same as the processing in the first embodiment. If the code information input to the input unit 4001 is not the store exit code in the processing in Act 101 (N in Act 101), for example, if the code information is a barcode indicating the payment completion information, the control unit 40 skips the processing in Act 102 and Act 103 and shifts to the processing in Act 32.

According to the exemplary processing explained above, if the store exit code is input to the input unit 4001, the processing unit 4004 refers to the status management file 213, which is the registration-information storing unit, and allows passage of the customer without executing the error processing on condition that a registered commodity is absent.

With the sales management system 1 in the third exemplary embodiment, if the store exit code is input to the gate device 4, the gate device 4 performs the status check and allows passage of the customer without executing the error processing on condition that a registered commodity is absent. Therefore, as in the second embodiment, the sales management system 1 has an advantage that a fraudulent store exit of the customer can be further suppressed in addition to the advantage of the sales management system 1 in the first embodiment.

As explained above, the sales management system in the embodiment is a sales management system including: a registration device including a processor configured to perform commodity registration based on operation of a customer who purchases a commodity; and a gate device including a processor configured to execute error processing in response to receiving, as an input, information indicating that payment for the commodity registered by the registration device is completed is not input when the customer passes the gate device, wherein the processor of the registration device is further configured to: receive stop information indicating that the customer stops shopping without purchasing the commodity; and in response to receiving the stop information, output information for passing the gate device, and wherein the processor of the gate device is further configured to: receive, as the input, the information for passing the gate device; and in response to receiving, as the input, the information for passing the gate device, allow passage of the customer without executing the error processing.

Consequently, even a customer who enters the selling floor but does not purchase any commodity and stops shopping can pass the gate device 4 and normally exit the selling floor. Therefore, the sales management system in the embodiment has an advantage that it is possible to secure convenience of a customer while suppressing a fraudulent act of the customer.

The sales management system in the exemplary embodiment may further include a commodity-registration-information storing unit in which commodity registration information indicating presence or absence of a commodity registered based on operation of the customer is stored, and, if the receiving unit receives the stop information, the output unit of the registration device may refer to the commodity-registration-information storing unit and output the information for passage on condition that a registered commodity is absent.

Consequently, the portable terminal 5 prevents the information for passage from being output in a state in which the commodity registration is not cancelled and the commodity is not returned. Therefore, the sales management system in the embodiment can further suppress a fraudulent act of the customer.

Further, the sales management system in the exemplary embodiment may further include a commodity-registration-information storing unit in which commodity registration information indicating presence or absence of a commodity registered based on operation of the customer is stored, and, if the information for passage is input to the input unit, the processing unit of the gate device may refer to the commodity-registration-information storing unit and allow passage of the customer without executing the error processing on condition that a registered commodity is absent.

Consequently, the gate device 4 executes the error processing if the customer attempts to exit the selling floor in a state in which the commodity registration is not cancelled and the commodity is not returned. Therefore, the sales management system in the embodiment can further suppress a fraudulent act of the customer.

Moreover, the commodity-registration-information storing unit of the sales management system in the exemplary embodiment may be a status management file for managing a status of the customer based on operation of the registration device.

Consequently, as a component for checking that a registered commodity is absent after the stop information is input to the registration device, it is possible to utilize the stored status management file in order to manage the status of the customer. Therefore, it is possible to simplify a component for checking that a registered commodity is absent after the stop information is input to the registration device.

In addition, the registration device of the sales management system in the exemplary embodiment maybe a portable terminal carried by the customer, and the output unit may display a code symbol indicating the information for passage on the display unit of the portable terminal.

Consequently, the customer can execute, with the portable terminal, the commodity registration and display the code symbol indicating the information for passage. For example, the customer does not need to print the code symbol indicating the information for passage in the checkout device or the like. Therefore, it is possible to suppress convenience of the customer from being deteriorated.

In the exemplary embodiments explained above, the control programs to be executed by the store server 2, the checkout device 3, the gate device 4, and the portable terminal 5 may be provided while being recorded in a computer-readable recording medium such as a CD-ROM. The control programs to be executed by the store server 2, the checkout device 3, the gate device 4, and the portable terminal 5 in the embodiments may be stored on a computer connected to a network such as the Internet and provided by being downloaded through the network. Further, the control programs may be provided through the network such as the Internet.

The exemplary embodiments are explained above. However, the exemplary embodiments are presented as examples and are not intended to limit the scope of the invention. The embodiments can be implemented in other various forms. Various omissions, substitutions, and changes can be made without departing from the spirit of the invention.

For example, in the exemplary embodiments, the commodity information stored by the commodity registration is stored in the transaction-information storing unit 504 of the portable terminal 5. However, the commodity information may be stored in the store server 2. Specifically, if reading a commodity code, the portable terminal 5 transmits the commodity code and the terminal ID to the store server 2. The store server 2 reads out commodity information corresponding to the received commodity code from the commodity master 212 and stores the read-out commodity information and the terminal ID in association with each other. If receiving information indicating registration cancellation, the terminal ID, and the commodity code from the portable terminal 5, the store server 2 clears the relevant commodity information. In other words, the store server 2 may manage, for each terminal ID, commodity information of a commodity, a commodity code of which is read by the portable terminal 5. In this case as well, the commodity information is registered based on operation of the portable terminal 5. Therefore, the portable terminal 5 can be considered the registration device.

If determining whether the information indicating the shopping stop is input to the portable terminal 5 and transaction information is stored (for example, Act 14 in FIG. 14), the portable terminal 5 acquires, from the store server 2, information concerning whether the transaction information is stored. The transaction information is input to the checkout device 3 from the store server 2. Specifically, if the terminal ID is input to the checkout device 3, the checkout device 3 acquires transaction information corresponding to the terminal ID from the store server 2.

What is claimed is:

1. A sales management system comprising:
a registration device including a processor configured to perform commodity registration based on operation of a customer who purchases a commodity; and
a gate device including a processor configured to execute error processing in response to receiving, as an input, information indicating that payment for the commodity registered by the registration device is completed is not input when the customer passes the gate device,
wherein the processor of the registration device is further configured to:
receive stop information indicating that the customer stops shopping without purchasing the commodity; and
in response to receiving the stop information, output information for passing the gate device, and
wherein the processor of the gate device is further configured to:
receive, as the input, the information for passing the gate device; and
in response to receiving, as the input, the information for passing the gate device, allow passage of the customer without executing the error processing.

2. The system according to claim 1, wherein the processor of the registration device is further configured to store commodity registration information indicating presence or absence of a commodity registered based on operation of the customer,
wherein, in response to the registration device receiving the stop information, the processor of the registration device is further configured to refer to and output the information for passage indicating that a registered commodity is absent.

3. The system according to claim 1, wherein the processor of the registration device is further configured to store commodity registration information indicating presence or absence of a commodity registered based on operation of the customer,
wherein, in response to receiving the information for passage, the processor of the gate device is further configured to refer to and allow passage of the customer without executing the error processing indicating that a registered commodity is absent.

4. The system according to claim 2, wherein the processor of the registration device is further configured to execute a status management file for managing a status of the customer based on operation of the registration device.

5. The system according to claim 1, wherein
the registration device is a portable terminal carried by the customer, and
the processor of the registration device is further configured to display a code symbol indicating the information for passage on a display of the portable terminal.

6. The system according to claim 1, wherein, as the error processing, the processor of the registration device is further configured to output a message for urging the customer to make payment.

7. A method for registering information in a sales management system including a registration device having a processor and a gate device having a processor, the method comprising:
receiving, by the registration device, stop information indicating that the customer stops shopping without purchasing the commodity;
in response to receiving the stop information, output, by the registration device, information for passing the gate device;
receive, by the gate device, the information for passing the gate device; and
in response to receiving the information for passing the gate device, allow, by the gate device, passage of the customer without executing the error processing.

8. The method according to claim 7, further comprising:
storing, by the registration device, commodity registration information indicating presence or absence of a commodity registered based on operation of the customer; and
in response to the registration device receiving the stop information, referring to and outputting, by the registration device, the information for passage indicating that a registered commodity is absent.

9. The method according to claim 7, further comprising:
storing, by the registration device, commodity registration information indicating presence or absence of a commodity registered based on operation of the customer; and
in response to receiving the information for passage, referring to and allowing, by the gate device, passage of the customer without executing the error processing indicating that a registered commodity is absent.

10. The method according to claim 8, wherein the registration device including the processor is further configured to execute a status management file for managing a status of the customer based on operation of the registration device.

11. The method according to claim 7, further comprising:
displaying, by the registration device, a code symbol indicating the information for passage on a display of the portable terminal, wherein the registration device is a portable terminal carried by the customer.

12. The method according to claim 7, further comprising:
outputting, as the error processing by the registration device, a message for urging the customer to make payment.
